(19) United States
(12) Patent Application Publication
(10) Pub. No.: US 2014/0379358 A1
(43) Pub. Date: Dec. 25, 2014

(54) INSERTION-SITE DECISION-SUPPORT SYSTEMS AND METHODS

(71) Applicant: LifeScan, Inc., Milpitas, CA (US)

(72) Inventors: Sweta CHOVANDA, Exton, PA (US); Shawn Berven, Philadelphia, PA (US)

(21) Appl. No.: 13/924,968

(22) Filed: Jun. 24, 2013

(51) Int. Cl. G06F 19/00

(52) U.S. Cl. CPC G06F 19/3418
USPC 705/2

(57) ABSTRACT

A decision support system for a patient includes a storage device holding data of various insertion sites. Each site represents an area on a human body at which a medical device can be inserted into the body. Also stored are data indicative of sites that have been used by the patient. A processor determines whether various sites are recommended and indicates recommendations on a display. The processor receives a selection of a site and updates the stored data. The system can also determine recommendations for two different medical devices and update stored data indicative of the used sites for one of them with a selected site. A method of recommending an insertion site includes receiving an indication of a site that should not be used, determining whether each of the sites is recommended using the indication, displaying the recommendations and updating the stored data based on a received user selection.

### TECHNICAL FIELD

This application relates generally to the field of electronic systems and computer-implemented methods that store medical records of a user, and more specifically to systems and methods for recommending insertion sites for medical devices.

### BACKGROUND

Diabetes mellitus is a chronic metabolic disorder caused by an inability of the pancreas to produce sufficient amounts of the hormone insulin, resulting in the decreased ability of the body to metabolize glucose. This failure leads to hyperglycemia, i.e. the presence of an excessive amount of glucose in the blood plasma. Persistent hyperglycemia and hypoinsulinemia have been associated with a variety of serious symptoms and life-threatening long-term complications such as dehydration, ketoacidosis, diabetic coma, cardiovascular diseases, chronic renal failure, retinal damage and nerve damages with the risk of amputation of extremities. Because restoration of endogenous insulin production is not yet possible, a permanent therapy is necessary which provides constant glycemic control in order to always maintain the level of blood glucose within normal limits. Such glycemic control is achieved by regularly supplying external insulin to the body of the patient to thereby reduce the elevated levels of blood glucose.

External biologic agents such as, for example, insulin or its analogs, can be administered as multiple daily injections of a mixture of rapid and intermediate-acting drugs via a hypodermic syringe. Improved glycemic control can be achieved by the so-called “intensive hormone” therapy which is based on multiple daily injections, including one or two injections per day of a long acting hormone for providing basal hormone and additional injections of rapidly acting hormone before each meal in an amount proportional to the size of the meal. Although traditional syringes have at least partly been replaced by insulin pens, the frequent injections are nevertheless very inconvenient for the patient, particularly those who are incapable of reliably self-administering injections. For some patients, substantial improvements in diabetes therapy have been achieved by the development of drug delivery devices, such as pumps, that relieve the patient of the need for syringes or drug pens and the need to administer multiple daily injections. Drug delivery devices can be constructed as an implantable device for subcutaneous arrangement or can be constructed as an external device with an infusion set for subcutaneous infusion to the patient via the transcutaneous insertion of a catheter, cannula or a transdermal drug transport, such as through a patch.

Blood or interstitial glucose monitoring can be used to achieve acceptable glycemic control. The determination of blood glucose concentration can be performed by means of an episodic measuring device, such as a hand-held electronic blood-glucose meter, that receives blood samples on enzyme-based test strips and calculates the blood glucose value based on an electrochemical reaction of the blood and the enzyme. An example of a handheld glucose meter/controller unit is the ONETOUCH PING™ from JOHNSON & JOHNSON®. Continuous glucose monitoring (CGM) using a sensor inserted into or implanted in the body can also be used. A combination of a CGM and a drug delivery device can be used to provide closed loop control of the insulin(s) being infused into the diabetic patients. To allow for closed-loop control of the infused insulins, proportional-integral-derivative (“PID”) controllers and model predictive controllers (MPC) have been used. The term “continuous” is convenient, but not strictly accurate. In practice, CGM sensors generally sample glucose on a regular time scale, e.g., once per five minutes. Closed-loop control updates can be performed, e.g., in the time intervals between glucose measurements.

Drug delivery devices generally provide insulin at a “basal rate,” i.e., provide a certain amount of insulin every few minutes in a pre-programmed, daily pattern. Some drug delivery devices also permit the user to specify a “temporary basal,” in which the normal daily cycle is altered for a selected length of time. Some drug delivery devices permit the user to manually request that a “bolus,” a specified amount of insulin, be delivered at a specified time. For example, before a meal, the user can request a bolus of additional insulin be delivered to process the glucose produced by digestion of the meal. Some drug delivery devices permit the specified amount to be delivered over a period of time rather than all at once; time-extended delivery is referred to as an “extended bolus.”

Insulin delivery, whether through syringe, pen, or infusion, is preferably done in specific sites on the body to provide improved absorption of insulin. Insulin is most rapidly absorbed when delivered in the abdomen, followed by the upper arm and thigh area. Drugs delivered into the hip and buttock areas are more slowly absorbed. Insulin is preferably delivered subcutaneously, and more preferably delivered into an area with fatty tissue to guard against accidental delivery of insulin into muscle or a blood vessel. As a result, there are a limited number of regions of the body to which drugs can be delivered. Furthermore, repeated delivery of insulin into the same area is likely to result in the development of fat deposits that can make the skin look lumpy, lead to scar tissue build-up and delay the absorption of insulin. This can then lead to erratic blood glucose values. Repeated insertion of CGM sensor probes into the same area can weaken the tissue in that area or cause damage over time. Therefore, it is known that it is desirable for patients to rotate insertion sites.

As used here, an “insertion site” is an area on a human body at which a medical device can be inserted into the body, e.g., for injecting or infusing insulin or other drugs, or for sensing properties of the body such as glucose level. The medical device can be inserted only for long enough to perform a specific function, e.g., inject an insulin dose, or can be left in the body, e.g., for 2-7 days. “Rotating” insertion sites refers to the process of choosing a different insertion site every nth time a medical device is to be inserted into the body, n>1. However, rotating insertion sites requires remembering which sites have been used and how recently. Remembering these data can be difficult for many patients.

### SUMMARY OF THE DISCLOSURE

In one embodiment, therefore, we have devised a decision support system for a patient. The system may include the following components:
a) a user interface including a display and an input device;
b) a processor coupled to the user interface to provide graphic output and receive input; and
c) a storage device coupled to the processor and holding:
   i) data of a plurality of insertion sites, each insertion site representing an area on a human body at which a medical device can be inserted into the body; and
   ii) data indicative of the insertion sites that have been used by the patient;
d) the processor being configured to receive via the user interface medical records of the patient and an indication of an insertion site that should not be used and store the medical records and the indication in the storage device, so that the processor:
   i) determines whether each of the insertion sites is recommended via the stored medical records, the stored indication, the data of the plurality of insertion sites, and the data indicative of the used insertion sites;
   ii) presents on the display a visual representation of at least some of the insertion sites and whether each of the at least some of the insertion sites is recommended;
   iii) receives a selection of one of the displayed insertion sites via the user interface; and
   iv) updates the stored data indicative of the used insertion sites with the selected one of the insertion sites.

In another embodiment, we have devised a decision support system for a patient. The system may include the following components:
a) a user interface including a display and an input device;
b) a processor coupled to the user interface to provide graphic output and receive input; and
c) a storage device coupled to the processor and holding:
   i) data of a plurality of insertion sites, each insertion site representing an area on a human body at which a medical device can be inserted into the body;
   ii) medical records of the patient;
   iii) data indicative of the insertion sites that have been used by the patient for a first medical device; and
   iv) data indicative of the insertion sites that have been used by the patient for a second medical device different from the first medical device;
d) the processor being configured to determine that each of the insertion sites is recommended for the first medical device, the second medical device, both of the medical devices, or neither of the medical devices via the stored medical records, the stored indication, the data of the plurality of insertion sites, and the data indicative of the used insertion sites for the first and second medical devices,
so that the processor:
   i) presents on the display a visual representation of at least some of the insertion sites and the determined respective recommendations;
   ii) receives via the input device a selection of one of the displayed insertion sites and a selection of one of the medical devices; and
   iii) updates the stored data indicative of the used insertion sites for the selected one of the medical devices with the selected one of the insertion sites.

In another embodiment, we have devised a method of recommending an insertion site. The method can be achieved by automatically performing the following steps using a processor:
receiving, via a user interface, medical records of a patient and an indication of an insertion site that should not be used;
storing the medical records and the indication in a storage device;
determining whether each of the insertion sites is recommended using the stored medical records, the stored indication, stored data of a plurality of insertion sites, and stored data indicative of the used insertion sites;
displaying a visual representation of the plurality of insertion sites;
receiving a selection of one of the insertion sites via the user interface;
updating the stored data indicative of the used insertion sites with the selected one of the insertion sites; and
repeating the determining, displaying, receiving, or updating steps at the request of the patient.

These embodiments exemplary of the present invention provide improved management of insertion sites and rotation patterns. Various embodiments provide the patient with data regarding recently-used insertion sites so that the patient does not have to remember patterns or sites. Various embodiments assist users in tracking rotation of multiple medical devices. Various embodiments permit users to mark insertion sites that should not be used.

Accordingly, in any of the embodiments described earlier, the following features may also be utilized in various combinations with the previously disclosed embodiments. For example, the decision support system can include the processor further configured to repeatedly determine the recommendations, present the representations, receive the selections, and update the stored data; the processor configured to determine whether the selected one of the insertion sites is not recommended and, if not, to present an indication on the display; the processor configured to determine whether there is likely to be subcutaneous fat in the patient's body at each of the plurality of insertion sites using the stored medical records, so that the processor determines that each of the plurality of insertion sites is recommended only if there is likely to be subcutaneous fat at that one of the plurality of insertion sites; the processor configured to present the visual representation of one or more of the insertion sites that are different from the insertion site indicated as the one that should not be used; or the input device including a touch sensor configured or otherwise operatively arranged with respect to the display to form a touchscreen, and the processor configured to receive the selection by detecting a touch on the touchscreen at a location corresponding to the visual representation of one of the displayed insertion sites.

In various examples, the decision support system can include the processor configured to receive an indication of one of the plurality of insertion sites that is in use by the first medical device, so that the processor determines that each of the plurality of insertion sites within a selected distance of the indicated insertion site is not recommended for the second medical device; the processor configured to present the visual representation showing only ones of the plurality of insertion sites that are recommended for the selected one of the medical devices or both of the medical devices; the storage device storing data defining a medical criterion applicable to a selected one of the plurality of insertion sites and a selected one of the medical devices, and the processor configured to determine whether the stored medical records satisfy the criterion and, if not, that the selected one of the insertion sites is not recommended for the selected one of the medical devices; the processor configured to determine that each of the plurality of insertion sites is recommended for one of the medical devices only if that one of the plurality of insertion sites is not indicated in the stored data for the corresponding one of the medical devices as having been used less than a selected time ago; or the input device including a touch sensor configured with respect to the display to form a touchscreen, and the processor configured to receive the selection of one of the displayed insertion sites by detecting a touch on the touchscreen at a location corresponding to the visual representation of the one of the displayed insertion sites.

In various examples, the method can include determining whether the selected one of the insertion sites is recommended, and if not, displaying an indication; receiving a second indication of an insertion site that should not be used; automatically replacing the stored indication in the storage device with the second indication using the processor; automatically storing the second indication in the storage device so that whether each of the insertion sites is recommended is further determined using the stored second indication; the medical records including one or more items selected from the group consisting essentially of an indication of whether the patient has Type I diabetes or Type II diabetes, a height of the patient, a weight of the patient, a gender of the patient, and an age of the patient, and combinations thereof; displaying the visual representations including displaying a visual representation of whether each of the plurality of insertion sites is recommended; or displaying the visual representation including displaying the visual representation on a touchscreen in the user interface.

In the aforementioned aspects of the disclosure, the steps of extracting, defining, obtaining, dividing, displaying, deriving, determining, calculating, replacing, and/or storing (possibly in conjunction with an equation) may be performed be an electronic circuit or a processor. These steps may also be implemented as executable instructions stored on a computer readable medium; the instructions, when executed by a computer may perform the steps of any one of the aforementioned methods.

In additional aspects of the disclosure, there are computer readable media, each medium comprising executable instructions, which, when executed by a computer, perform the steps of any one of the aforementioned methods.

In additional aspects of the disclosure, there are devices, such as test meters or analyte testing devices, each device or meter comprising an electronic circuit or processor configured to perform the steps of any one of the aforementioned methods.

These and other embodiments, features and advantages will become apparent to those skilled in the art when taken with reference to the following more detailed description of various exemplary embodiments of the invention in conjunction with the accompanying drawings that are first briefly described.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention. For the sake of clarity, like reference numerals herein represent like elements.

FIG. 1 illustrates an exemplary glucose-monitoring and drug delivery system and related components.

FIG. 2 shows an exemplary biosensor.

FIG. 3 shows an exemplary decision-support system for the management of insertion sites, and related components.

FIG. 4 shows an exemplary decision-support system for a patient.

FIGS. 5-9 are graphical representations of screenshots of an exemplary decision-support system including a software application.

FIG. 10 shows an exemplary presentation of a visual representation of a human body.

FIG. 11 is a flowchart illustrating an exemplary method for recommending an insertion site.

### MODES FOR CARRYING OUT THE INVENTION

The following detailed description should be read with reference to the drawings, in which like elements in different drawings are identically numbered. The drawings, which are not necessarily to scale, depict selected embodiments and are not intended to limit the scope of the invention or the attached claims.

As used herein, the terms “about” or “approximately” for any numerical values or ranges indicate a suitable dimensional tolerance that allows the part or collection of components to function for its intended purpose as described herein. More specifically, “about” or “approximately” may refer to the range of values not at least ±10% of the recited value, e.g. “about 90%” may refer to the range of values from 81% to 99%. As used herein, “oscillating signal” includes voltage signal(s) or current signal(s) that, respectively, change polarity or alternate direction of current or are multi-directional. Also used herein, the phrase “electrical signal” or “signal” is intended to include direct current signal, alternating signal or any signal within the electromagnetic spectrum. The terms “processor”; “microprocessor”; or “microcontroller” are intended to have the same meaning and are intended to be used interchangeably. Throughout this disclosure, the terms “patient” and “subject” are used interchangeably. These terms can refer to any human or animal subject and are not intended to limit the systems or methods to human use, although use of the subject invention in a human patient represents a preferred embodiment. Furthermore, in this disclosure, the term “user” can refer to a patient using a glucose measuring or drug delivery device or another person (e.g., a parent or guardian, nursing staff member, home care employee, or other caretaker) using such a device. The term “healthcare provider” or “HCP” refers generally to doctors, nurses, and individuals other than the patient that provide health care services to the patient. The term “drug” may include hormones, biologically active materials, pharmaceuticals or other chemicals that cause a biological response (e.g., a glycemic response) in the body of a user or patient.

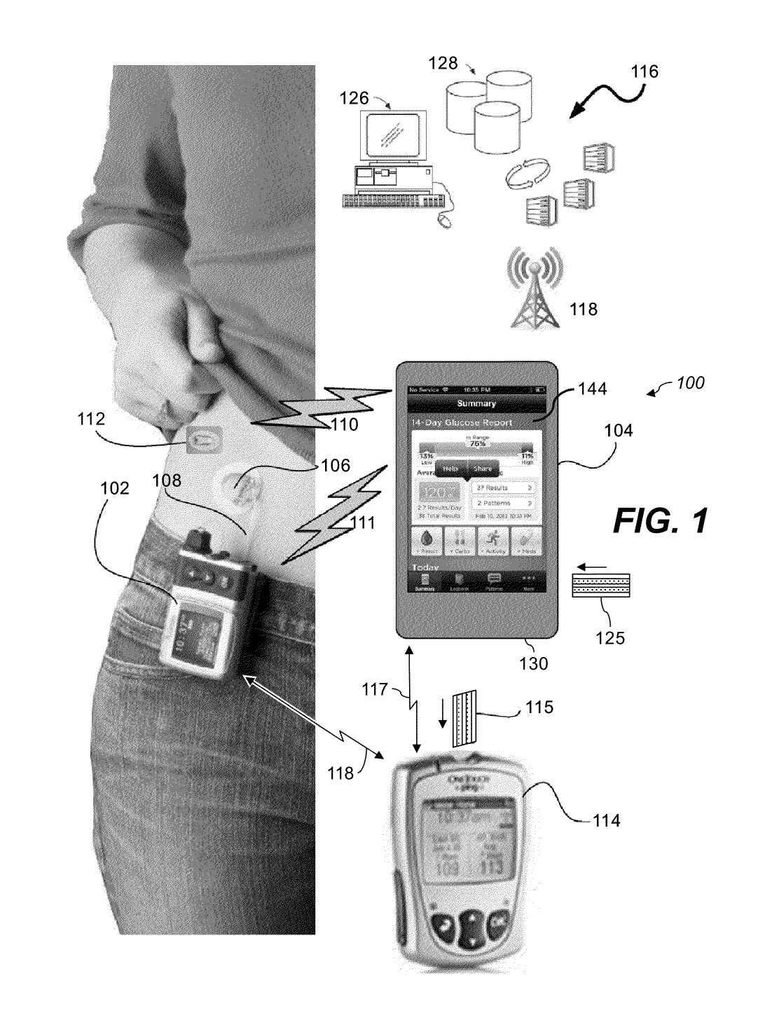

FIG. 1 illustrates a glucose-monitoring and drug delivery system 100, e.g., an artificial pancreas, according to an exemplary embodiment. A drug delivery system 100 includes a drug delivery device 102 and a controller 104. The drug delivery device 102 is connected to an infusion set 106 via flexible tubing 108. Various embodiments of the invention can also be used with injections via syringe or insulin pen instead of or in addition to infusion via the drug delivery device 102.

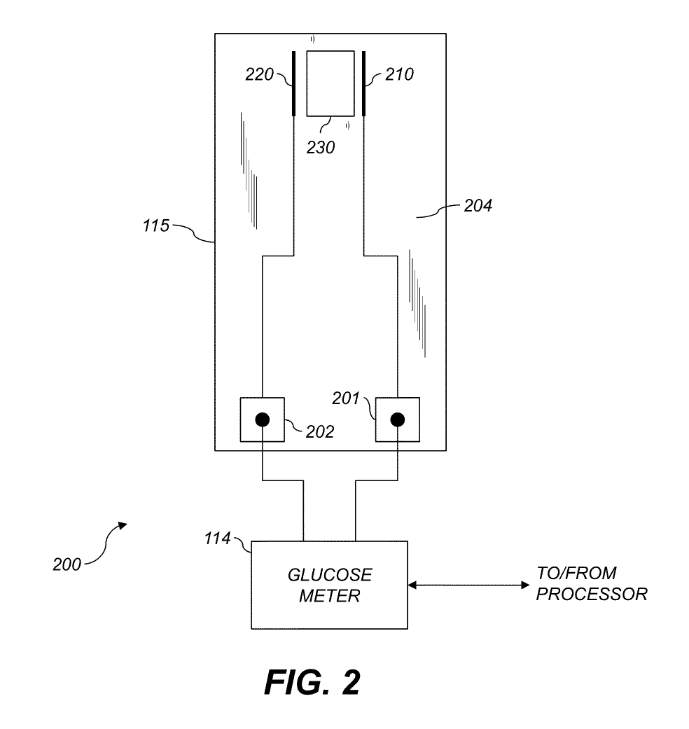

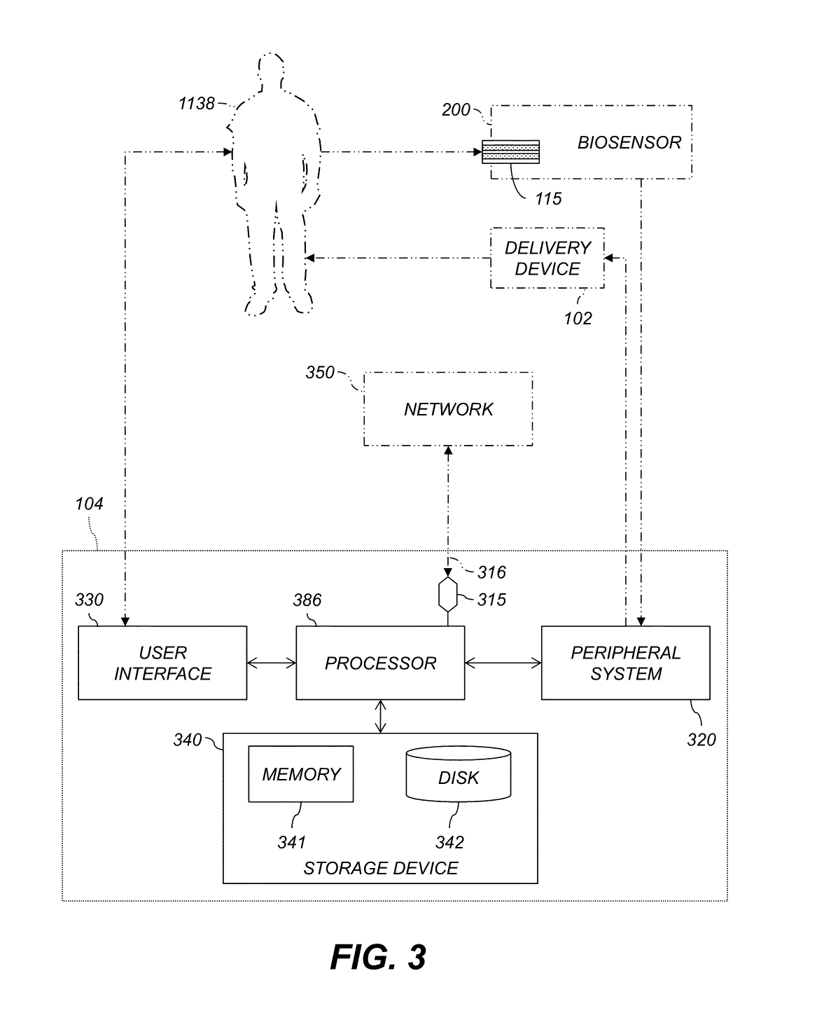

The drug delivery device 102 is configured to transmit and receive data to and from the controller 104 by, for example, a radio frequency (RF) communications link 111. In one embodiment, the drug delivery device 102 is an insulin infusion device and the controller 104 is a hand-held portable controller. In such an embodiment, data transmitted from the drug delivery device 102 to the controller 104 may include information such as, for example, insulin delivery data, blood glucose (BG) information, basal, bolus, insulin to carbohydrates ratio or insulin sensitivity factor. The controller 104 can be configured to include a closed-loop controller that has been programmed to receive continuous glucose readings from a CGM sensor 112 via a radio frequency (RF) communications link 110. The CGM sensor 112 can measure glucose levels of interstitial fluid in the body, determine corresponding blood glucose levels, and provide the BG levels to the controller 104. Data transmitted from the controller 104 to the drug delivery device 102 may include glucose test results and a food database to allow the drug delivery device 102 to calculate the amount of insulin to be delivered by the drug delivery device 102. Alternatively, the controller 104 may perform basal dosing or bolus calculation and send the results of such calculations to the drug delivery device. A glucose meter 114 (here, an episodic blood-glucose meter), alone or in conjunction with the CGM sensor 112, provides data to either or both of the controller 104 and drug delivery device 102, e.g., via a radio frequency (RF) communications link 117. The glucose meter 114 can measure a fluid sample placed on a test strip 115. The two hatched areas on the test strip 115 graphically represent two electrodes, as is discussed below with reference to FIG. 2. The controller 104 can present information and receive commands via a touchscreen 144 or other devices discussed below with reference to the user interface 330, FIG. 3. The CGM sensor 112 in this embodiment measures glucose values in interstitial fluids and can provide data that are representative of or proportional to present blood-glucose values, e.g., directly to the drug delivery device 102 via a radio frequency (RF) communications link 113 or a wired connection such as a Universal Serial Bus (USB) cable.

The controller 104, the drug delivery device 102, and the CGM sensor 112 can be integrated into multi-function units in any combination. For example, the controller 104 can be integrated with the drug delivery device 102 to form a combined device with a single housing. Infusion, sensing, and controlling functions can also be integrated into a monolithic artificial pancreas. In various embodiments, the controller 104 is combined with the glucose meter 114 into an integrated monolithic device having a housing 130. Such an integrated monolithic device can receive a test strip 125. In other embodiments, the controller 104 and the glucose meter 114 are two separable devices that are dockable with each other to form an integrated device. Each of the devices 102, 104, and 114 has a suitable micro-controller (not shown for brevity) programmed to carry out various functionalities. Examples of micro-controllers that can be used are discussed below with reference to a processor 386, FIG. 3.

The drug delivery device 102 or the controller 104 can also be configured for bi-directional communication with a network 116 through, for example, a radio frequency communications link 118. One or more server(s) 126 or storage device(s) 128 can be communicatively connected to the controller 104 via the network 116. In an example, the drug delivery device 102 communicates with a personal computer (e.g., the controller 104) via BLUETOOTH™ low-energy (BLE™, also known as BLUETOOTH SMART). The controller 104 and the network 116 can be configured for bi-directional wired communication through, for example, a telephone land based communication network. The controller 104 can include a smartphone, electronic tablet, or personal computer.

The drug delivery device 102 can include any or all of: electronic signal processing components including a central processing unit and memory elements for storing control programs and operation data, a radio frequency module (not shown) for sending and receiving communication signals (e.g., messages) to and from the controller 104, a display for providing operational information to the user, a plurality of navigational buttons for the user to input information, a battery for providing power to the system, an alarm (e.g., visual, auditory or tactile) for providing feedback to the user, a vibrator for providing feedback to the user, and a drug delivery mechanism (e.g., a drug pump and drive mechanism) for forcing a insulin from a insulin reservoir (e.g., a insulin cartridge) through a side port connected via the flexible tubing 108 to an infusion set 106 and into the body of the user.

Various glucose management systems include an episodic glucose sensor (e.g., a glucose meter 114) and an infusion pump. An example of such a system is the ONETOUCH PING Glucose Management System manufactured by the Animas Corporation. The “ezBG” feature of this system computes an amount of insulin to be delivered by the infusion pump using the results of an episodic glucose measurement. Another example of a glucose management system is the ANIMAS VIBE™ insulin pump, which communicates with a DEXCOM G4™ CGM system manufactured by the DexCom Corporation. Interfaces can be provided to connect these components. Closed-loop control algorithms can be programmed in, e.g., the MATLAB™ language to regulate the rate of insulin delivery based on the glucose level of the patient, historical glucose measurement and anticipated future glucose trends, and patient specific information.

FIG. 2 shows an exemplary biosensor 200. The biosensor 200 is defined by a test strip 115 electrically connected to the glucose meter 114. (Other configurations of biosensors, e.g., continuous glucose monitors, can also be used with the glucose meter 114 or the controller 104.) The test strip 115 is defined by a planar substrate 204 over which are disposed electrodes 210, 220 and electrical contact pads 201, 202. The electrodes 210, 220 can be disposed on opposing sides of a sample-receiving chamber 230, above and below the sample-receiving chamber 230, or in other configurations. The glucose meter 114 can communicate with a processor, e.g., the controller 104, FIG. 1.

In the exemplary test strip 115, the electrode 220 is a working electrode formed by sputtering a Pd coating on a polyester base forming the planar substrate 204. A dry reagent layer is used and includes buffer, mediator, and enzyme, as described herein. The electrode 210 is a reference electrode formed by sputtering an Au coating on the polyester base forming the planar substrate 204. The electrical contact pads 201, 202 connect to the electrodes 210, 220, respectively, and permit applying or detecting electrical signals across the sample-receiving chamber 230 between the electrodes 210, 220. The sample-receiving chamber 230 can have a volume ranging from, e.g., about 0.1 microliters to about 5 microliters. Various enzymes in the sample-receiving chamber 230 can assist in transducing the analyte (e.g., glucose) in the fluid sample (e.g., blood, interstitial fluid, or control solution) into a current, potential, or other quantity that can be measured electrically. Exemplary enzymes include glucose oxidase, glucose dehydrogenase (GDH) based on a pyrroloquinoline quinone co-factor, and GDH based on a nicotinamide adenine dinucleotide co-factor.

In use, top ends of the electrodes 210, 220 are in contact with an electrolyte phase (not shown), which is a free-flowing fluid phase (e.g., a blood sample) disposed between the electrodes 210, 220. An enzyme, e.g., glucose oxidase, can cover the electrolyte phase. Depending on the state of the test strip 115, the electrode 210 can be a working electrode and the electrode 220 can be a counter electrode. In an example using glucose oxidase, a current is produced at the working electrode (and flows through the circuitry to the counter electrode). That current is representative of the concentration of glucose in the subject's body. The glucose meter 114 can measure the current through the electrodes 210, 220 to determine the glucose level of the fluid sample in the sample-receiving chamber 230. Exemplary glucose sensors and associated components are shown and described in U.S. Pat. Nos. 6,179,979, 8,163,162, and 6,444,115, which are incorporated by reference herein in their entireties.

An exemplary CGM sensor 112 utilizes amperometric electrochemical sensor technology to measure an analyte. The CGM sensor 112 includes three electrodes operably connected to the sensor electronics and covered by a sensing membrane and a biointerface membrane, which are attached by a clip.

The top ends of the electrodes are in contact with an electrolyte phase (not shown), which is a free-flowing fluid phase disposed between the sensing membrane and the electrodes. The sensing membrane may include an enzyme, e.g., analyte oxidase, which covers the electrolyte phase. The H₂O₂ produced from the analyte oxidase reaction further reacts at the surface of working electrode and produces two protons (2H+), two electrons (2e−), and one oxygen molecule (O₂). A potentiostat is used to measure the electrochemical reaction(s) at the electrode(s) by applying a constant potential between the working and reference electrodes to produce a current value. The current that is produced at the working electrode (and flows through the circuitry to the counter electrode) is proportional to the diffusional flux of H₂O₂. Accordingly, a raw signal may be produced that is representative of the concentration of analyte in the user's body, and therefore may be utilized to estimate a meaningful analyte value. Details of the sensor and associated components are shown and described in U.S. Pat. No. 7,276,029, which is incorporated by reference herein. The CGM sensor 112 can measure analyte levels in, e.g., interstitial fluid.

FIG. 3 shows an exemplary decision-support system for the management of insertion sites, including data-processing components for analyzing data and performing other analyses and functions described herein, and related components. A subject 1138, a network 350, a biosensor 200, and a drug delivery device 102 are not part of the system but are shown for purposes of context. The controller 104 can communicate with the biosensor 200 (that can receive the test strip 115), the drug delivery device 102, or the network 350. The processor 386 in the controller 104 can receive glucose data from the biosensor 200 (the CGM sensor 112, or the glucose meter 114 using the test strip 115) and provide control signals to the drug delivery device 102 to deliver insulin to the subject 1138.

The controller 104 can also include a peripheral system 320, a user interface 330, and a storage device 340 communicatively connected to the processor 386. The processor 386 includes one or more data processor(s) that implement processes of various embodiments described herein. A “data processor” is a device for processing data and can include a central processing unit (CPU), a desktop computer, a laptop computer, a mainframe computer, a personal digital assistant, a digital camera, a cellular phone, a smartphone, or any other device for processing data, managing data, or handling data, whether implemented with electrical, magnetic, optical, biological components, or otherwise. The phrase “communicatively connected” includes any type of connection, wired or wireless, between devices, data processors, or programs in which data can be communicated. Subsystems such as the peripheral system 320, the user interface 330, and the storage device 340 are shown separately from the processor 386 but can be stored completely or partially within the processor 386.

The storage device 340 includes or is communicatively connected with one or more tangible non-transitory computer-readable storage medium(s) configured to store information, including the information needed to execute processes according to various embodiments. The term “device” does not imply that storage device 340 include only one piece of hardware that stores data. A “tangible non-transitory computer-readable storage medium” as used herein refers to any non-transitory device or article of manufacture that participates in storing instructions which may be provided to the processor 386 for execution. Such a non-transitory medium can be non-volatile or volatile. Examples of non-volatile media include floppy disks, flexible disks, or other portable computer diskettes, hard disks, magnetic tape or other magnetic media, Compact Discs and compact-disc read-only memory (CD-ROM), DVDs, BLU-RAY disks, HD-DVD disks, other optical storage media, Flash memories, read-only memories (ROM), and erasable programmable read-only memories (EPROM or EEPROM). Examples of volatile media include dynamic memory, such as registers and random access memories (RAM).

Embodiments of the present invention can take the form of a computer program product embodied in one or more tangible non-transitory computer readable medium(s) having computer readable program code embodied thereon. Such medium(s) can be manufactured as is conventional for such articles, e.g., by pressing a CD-ROM. The program embodied in the medium(s) includes computer program instructions that can direct the processor 386 to perform a particular series of operational steps when loaded, thereby implementing functions or acts specified herein.

In an example, the storage device 340 includes a memory 341, e.g., a random-access memory, and a disk 342, e.g., a tangible computer-readable storage device such as a hard drive or a solid-state flash drive. Computer program instructions are read into the memory 341 from the disk 342, or a wireless, wired, optical fiber, or other connection. The processor 386 then executes one or more sequences of the computer program instructions loaded into the memory 341, as a result performing process steps and other processing described herein. In this way, the processor 386 carries out a computer implemented process that provides technical effects described herein. For example, blocks of the flowchart illustrations or block diagrams herein, and combinations of those, can be implemented by computer program instructions. The memory 341 can also store data used by running programs.

Program code to carry out methods described herein can execute entirely on a single processor 386 or on multiple communicatively-connected processors 386. For example, code can execute wholly or partly on a user's computer and wholly or partly on a remote computer, e.g., a server. The remote computer can be connected to the user's computer through the network 350. The user's computer or the remote computer can be non-portable computers, such as conventional desktop personal computers (PCs), or can be portable computers such as tablets, cellular telephones, smartphones, or laptops.

The peripheral system 320 can include one or more devices configured to provide digital content records or other data to the processor 386. For example, the biosensor 200 can be connected to the processor 386 via the peripheral system 320, e.g., using a BLUETOOTH SMART or other wireless link. The biosensor 200 can also be directly connected to the processor 386. The peripheral system 320 can also include digital still cameras, digital video cameras, cellular phones, or other data processors. The peripheral system 320 can also include one or more bus bridge(s), e.g., to communicatively connect devices having USB, FIREWIRE, RS-232, or other interfaces to the processor 386. The processor 386, upon receipt of data from a device in the peripheral system 320, can store that data in the storage device 340.

The processor 386 is communicatively connected to the user interface 330. The user interface 330 can include a mouse, a keyboard, another computer (connected, e.g., via a network or a null-modem cable), a microphone and speech processor or other device(s) for receiving voice commands, a camera and image processor or other device(s) for receiving visual commands, e.g., gestures, or any device or combination of devices from which data is input to the processor 386. In this regard, although the peripheral system 320 is shown separately from the user interface 330, the peripheral system 320 can be included as part of the user interface 330. In at least one embodiment, the user interface 330 can be operated by the subject 1138.

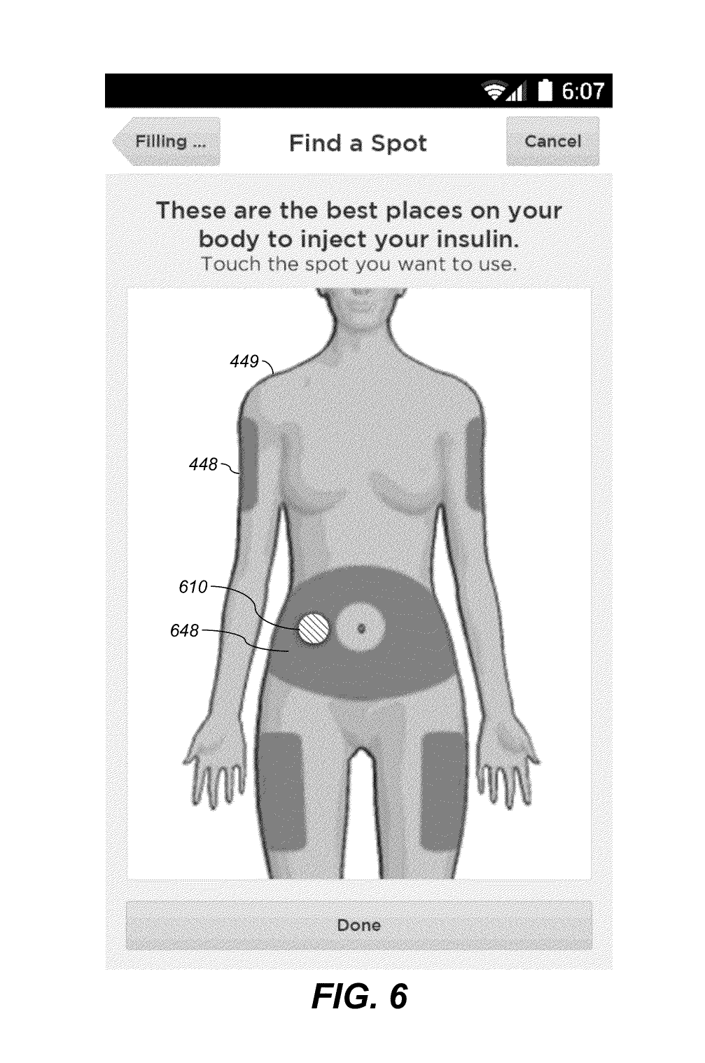

The user interface 330 also can include a display device, a touchscreen, a processor-accessible memory, or any device or combination of devices to which data is output by the processor 386. In this regard, if the user interface 330 includes a processor-accessible memory, such memory can be part of the storage device 340 even though the user interface 330 and the storage device 340 are shown separately in FIG. 6. For example, the user interface 330 can include one or more touchscreen(s), speaker(s), buzzer(s), vibrator(s), button(s), switch(es), jack(s), plug(s), or network connection(s).

In various embodiments, the processor 386 is communicatively connected to a communication interface 315 that is coupled via a network link 316 to the network 350. For example, the communication interface 315 can be a WIFI or BLUETOOTH SMART wireless transceiver and the network link 316 can be a radio-frequency (RF) communications channel. As another example, the communication interface 315 can be a network card to provide a data communication connection to a compatible local-area network (LAN), e.g., an Ethernet LAN, or wide-area network (WAN). The communication interface 315 sends and receives electrical, electromagnetic or optical signals that carry digital data streams representing various types of information across the network link 316 to the network 350. The network link 316 can be connected to the network 350 via a switch, gateway, hub, router, or other networking device.

The processor 386 can send messages and receive data, including program code, to and from the network 350 via the network link 316 and the communication interface 315. For example, requested code for an application program (e.g., a JAVA applet) can be stored on a tangible non-volatile computer-readable storage medium connected to the network 350. A network server (not shown) can retrieve the code from the medium and transmit it via the network 350 to the communication interface 315. The received code can be executed by the processor 386 as it is received, or stored in the storage device 340 for later execution.

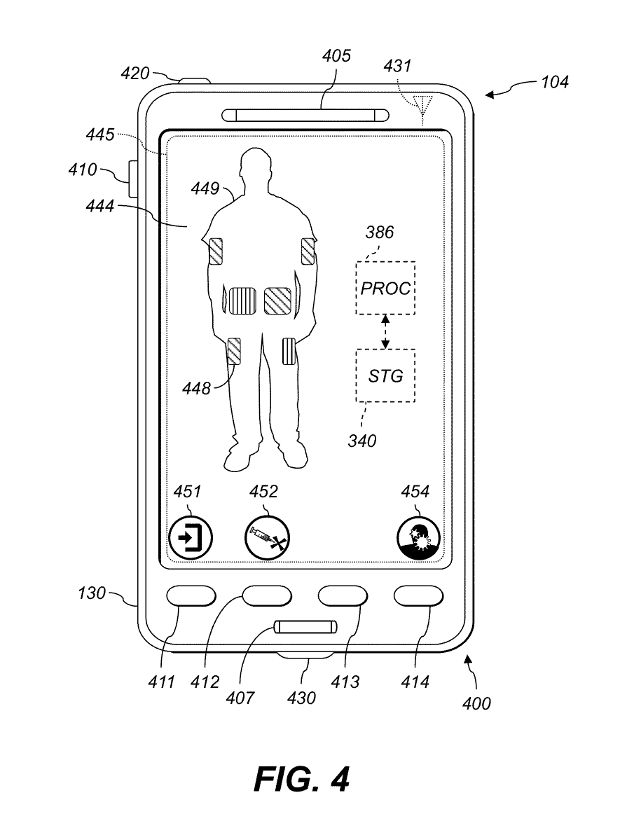

FIG. 4 shows an exemplary decision-support system 400 for a patient, including a controller 104 having a housing 130. The controller 104 can include a smartphone. Disposed within the housing 130 are the processor 386, the storage device 340 coupled to the processor 386, and an antenna 431. Disposed on the housing 130 are a headphone jack 420, a docking port 430, an earpiece 405, and a mouthpiece 407. Also arranged on the housing 130 are the elements of the user interface 330, including a display 444 and an input device. The processor 386 is coupled, as is well known to those skilled in the art, to the user interface 330 to provide graphic output and receive input. Examples of input devices include a joystick or a directional-pad pointing device (not shown), a switch 410, and soft keys 411, 412, 413, 414. In one example, the input device is a touch sensor 445 configured with respect to the display 444 to form a touchscreen. In the example shown, the soft key 411 permits entering a blood-glucose reading, indicated by a soft-key label 451. The soft key 412 requests assistance determining an insertion site, represented graphically by a soft-key label 452. The soft key 414 invokes a user-settings menu or dialog, represented graphically by a soft-key label 454.

The storage device 340 holds, e.g., in RAM or ROM, various data used by the processor 386. The storage device 340 holds data of a plurality of insertion sites, each insertion site representing an area on a human body at which a medical device can be inserted into the body, e.g., for injecting, pumping, or sensing, as described above. These data can be stored in a read-only memory. The storage device 340 also holds data indicative of the insertion sites that have been used by the patient (recently, or over a selected time horizon, as described below). These data can be stored in a nonvolatile read-write memory, e.g., a Flash memory. Examples of recommended insertion sites are described in Frid et al., “New injection recommendations for patients with diabetes,” Diabetes & Metabolism 36 (2010) S3-S18, DOI 10.1016/S1262-3636(10)70002-1 (“Frid”), incorporated herein by reference.

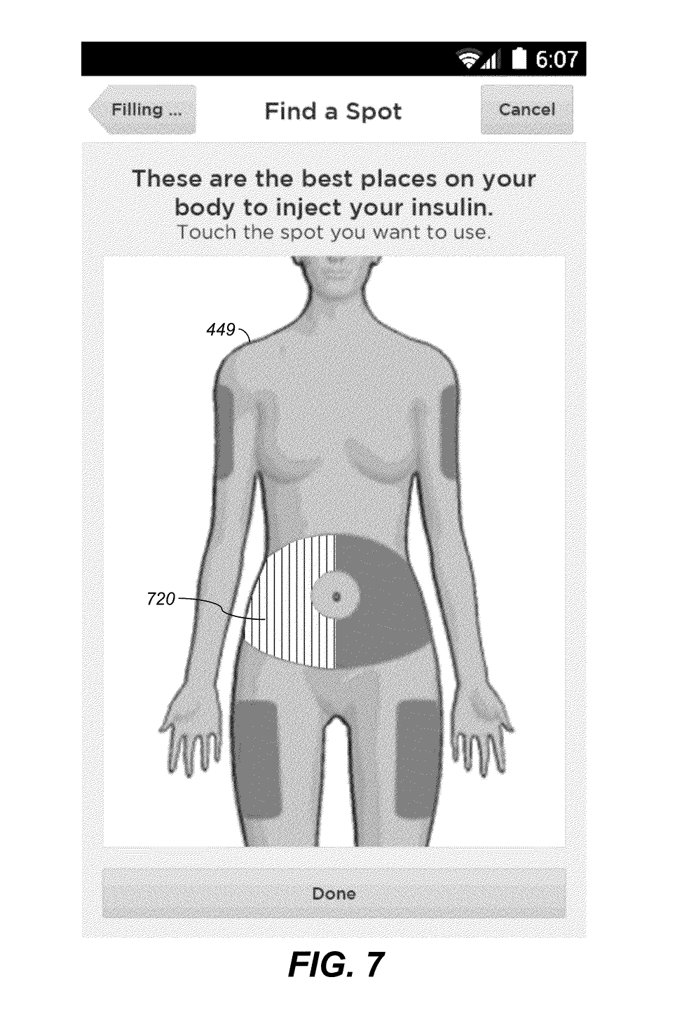

The data defining the plurality of insertion sites can have a desired spatial granularity. For example, Frid FIGS. 6 and 7 show rotation patterns that define four insertion sites around the abdomen and two insertion sites on each thigh or buttock. Data corresponding to this pattern would define insertion sites several inches on a side. These larger areas, sometimes referred to as “quadrants” or “halves,” can also be divided into smaller areas, sometimes referred to as “segments.” For example, a single quadrant can be divided into 1 cm×1 cm segments. In this example, each segment is one insertion site. Performing successive injections or insertions into the respective centers of different segments provides at least 1 cm between successive insertions, as recommended by Frid sec. 3.14.

The processor 386 is configured to receive via the user interface 330 medical records of the patient, e.g., via the settings dialog invoked by the soft key 414. The medical records can include any data reflective of past, present or predicted medical condition(s) of the patient such as, for example, one or more items such as an indication of whether the patient has Type I diabetes or Type II diabetes, a height of the patient, a weight of the patient, a gender of the patient, an age of the patient, or a body mass index (BMI) of the patient. Different medical records can be stored for different patients. For example, for one patient, height and weight can be stored; for another patient, BMI can be stored. An HCP can provide the medical records to the storage device 340 or can determine which medical records should be stored and used by the processor 386 in making determinations as described herein.

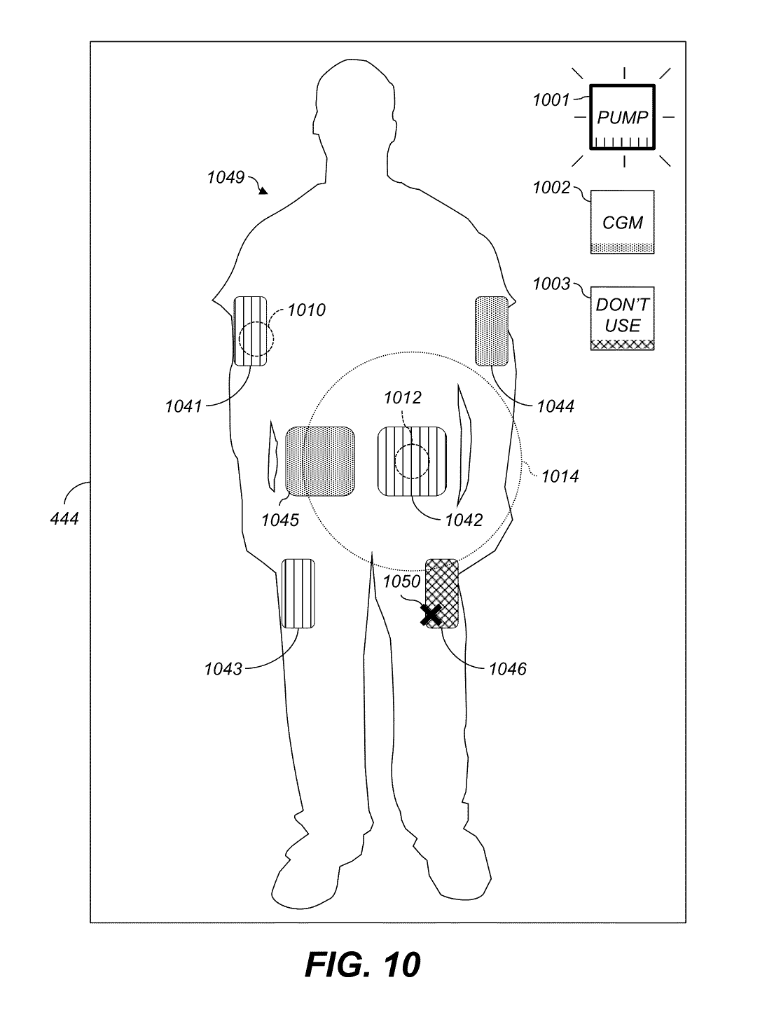

In various embodiments, the processor 386 is also configured to receive via the user interface an indication of an insertion site that should not be used and store the medical records and the indication in the storage device 340. This is discussed below with reference to an indication 1050, FIG. 10.

The processor 386 is configured to, e.g., in response to a user press of the soft key 412, determine whether each of the insertion sites is recommended using (via) the stored medical records, the stored indication, the data of the plurality of insertion sites, and the data indicative of the used insertion sites. The processor 386 presents on the display 444 a visual representation of at least some of the insertion sites and whether each is recommended. In an example, the processor displays the visual representation as one or more highlights 448 on a representation 449 of a human body. The highlights 448 are shown hatched; for clarity, only one of the highlights 448 is labeled. The different hatching patterns of the highlights 448 indicate that the highlights 448 can be displayed in different colors.

The processor 386 is further configured to receive a selection of one of the displayed insertion sites via the input device, and to update the stored data in the storage device 340 indicative of the used insertion sites with the selected one of the insertion sites. The representation 449 can be mirrored or not. That is, the labeled one of the highlights 448 can correspond to the user's left leg (as if viewed in a mirror) or to the user's right leg (as if viewing another person directly).

In various embodiments, the processor 386 is further configured to repeatedly determine the recommendations, present the representations, receive the selections, and update the stored data. In this way, the processor 386 can assist the user in consistently rotating between different insertion sites.

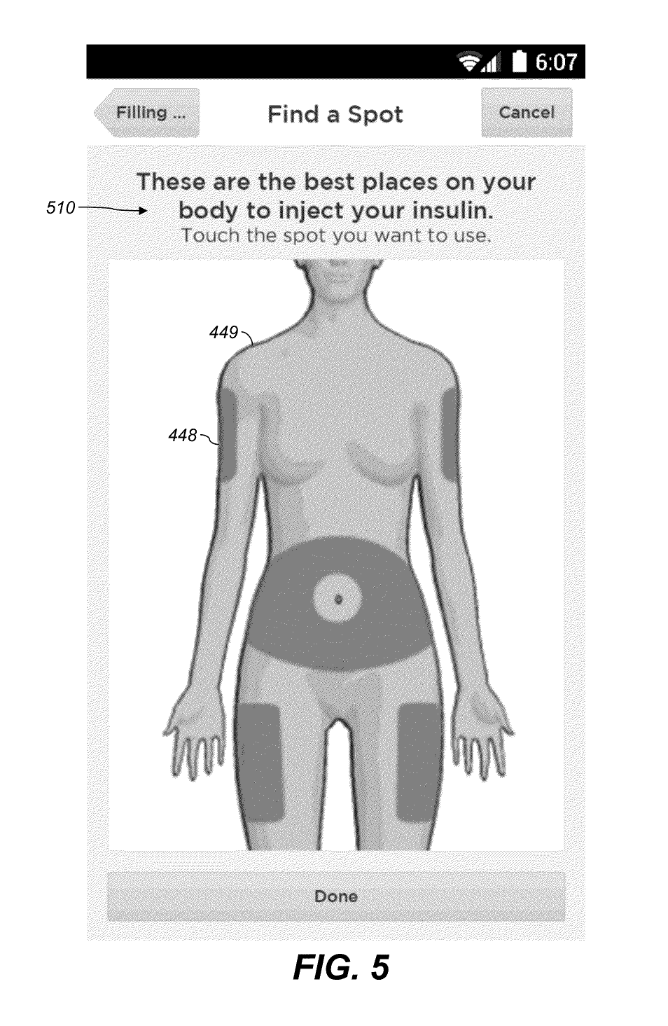

FIGS. 5-9 are graphical representations of screenshots of an exemplary software application (e.g., a smartphone app) running on the controller 104 (e.g., a smartphone). A screen as shown in FIG. 5 can be displayed in response to a user press of the soft key 412. In FIG. 5, the representation 449 and the highlights 448 are shown. The processor 386 displays this image with a prompt message 510 to request the user provide input indicative of a desired insertion site. When the user touches the touch sensor 445, FIG. 4, the processor 386 receives the location of the touch as input.

In FIG. 6, the processor 386 is displaying a touch indicator 610, e.g., a green circle (the color green is represented by the diagonal hatching, here and throughout). The touch indicator 610 shows the detected location of the user's touch. In this example, the input device is a touch sensor 445 configured with respect to the display 444 to form a touchscreen. The processor 386 is configured to receive the selection by detecting a touch on the touchscreen at a location corresponding to the visual representation of one of the displayed insertion sites, e.g., the highlight 648 corresponding to a right-abdomen insertion site. The processor 386 identifies the highlight 648 corresponding to the location touched and determines whether a corresponding one of the insertion sites is recommended.

In FIG. 7, the processor 386 is displaying a visual representation 720 of the corresponding one of the insertion sites. One highlight, e.g., the highlight 648, FIG. 6, can correspond to one or to more than one of the insertion sites. In this example, the highlight 648 represents two insertion sites: left abdomen and right abdomen. The right-abdomen insertion site is represented by the visual representation 720. In this example, the visual representation 720 is a red highlight, represented by the vertical-stripe hatch pattern of the visual representation 720 (and likewise throughout). In this example, the processor 386 is configured to determine whether the selected one of the insertion sites, i.e., the insertion site corresponding to the location of the touch indicator 610, is not recommended and, if not, to present an indication on the display 444, FIG. 4.

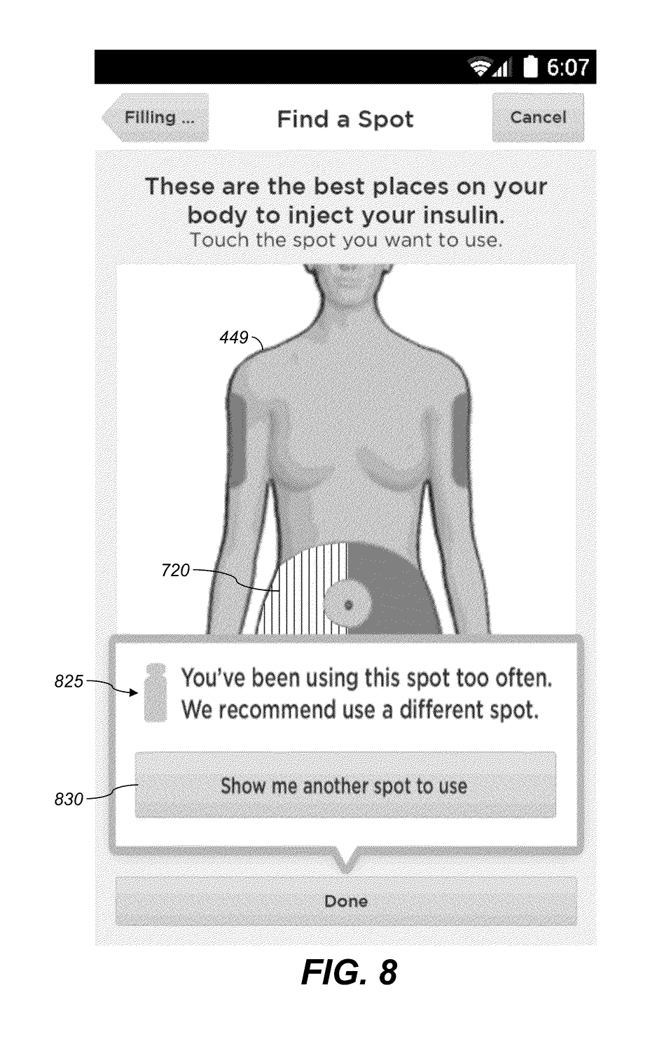

In FIG. 8, the processor 386 is displaying an explanatory message 825. The explanatory message 825 indicates why the visual representation 720 is red (the color indicated in FIG. 8 by the vertical-stripe hatch pattern). In this example, the visual representation 720 and the explanatory message 825 indicate that this insertion site (“spot”) has been used too often (or too recently). That is, the processor 386 has determined that the right-abdomen insertion site is not recommended. If the user presses or otherwise selects a graphical button 830 or a corresponding function, the processor 386 will recommend a different insertion site.

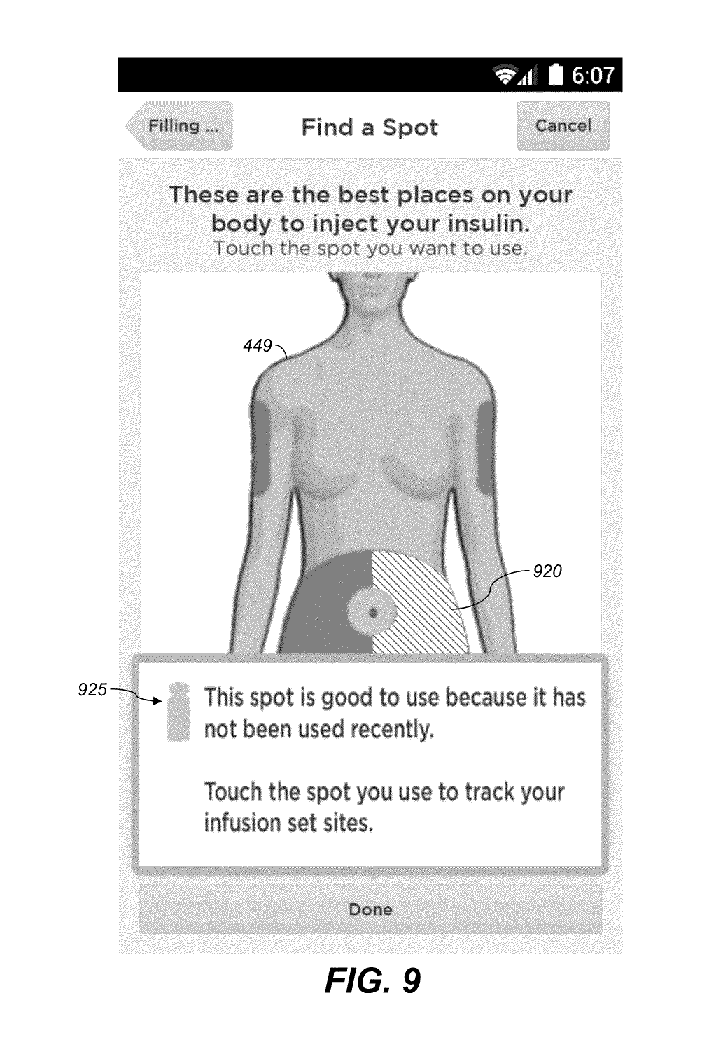

FIG. 9 depicts such a recommendation. The processor 386 is configured to select a different insertion site and display it with a visual representation 920. In this example, the visual representation 920 is a green region (color indicated by hatching) covering the left-abdomen portion of the highlight. An explanatory message 925 is displayed conspicuously to the user and explains that the insertion site corresponding to the visual representation 920 is recommended. In an example, the storage device 340 holds data defining a rotation pattern, e.g., a clockwise rotation around the abdomen, for example, as shown in Frid FIG. 6. The processor 386 selects the next insertion site in the defined rotation pattern, skipping insertion sites determined to be not recommended. In another example, the processor 386 selects the least-recently-used one of the recommended insertion site(s) and presents a corresponding visual representation 920. These and other techniques for selecting an insertion site known in the diabetes-care art can be used singly or in combination. In this and other examples, the processor 386 is configured to present the visual representation (e.g., the visual representation 920) of one or more of the insertion sites that are different from the insertion site indicated as the one that should not be used (e.g., of recommended insertion sites). Further examples of such representations are discussed below with reference to FIG. 10.

FIG. 10 shows an exemplary presentation of a visual representation 1049 of a human body. Referring to FIG. 10, and also to FIG. 4, a decision support system for a patient according to various embodiments includes the user interface 330 including the display 444 and an input device, e.g., the touch sensor 445. The processor 386 is coupled, as is well known to those skilled in the art, to the user interface 330 to provide graphic output and receive input. The storage device 340 is coupled, as is well known to those skilled in the art, to the processor 386 and holds data of a plurality of insertion sites, each insertion site representing an area on a human body at which a medical device can be inserted into the body, as discussed above.

The storage device 340 also holds medical records of the patient, data indicative of the insertion sites that have been used by the patient for a first medical device, and data indicative of the insertion sites that have been used by the patient for a second medical device different from the first medical device. Insertion sites can be tracked over a desired time horizon, e.g., the most recent week, month, six months, or year, or can be tracked indefinitely.

In an example, the first medical device is an insulin pump infusion set, e.g., the infusion set 106, FIG. 1, and the second medical device is a CGM sensor 112. In another example, the first medical device is a CGM sensor and the second medical device is an insulin needle. That is, as used herein, the term “medical device” includes multiple different devices used sequentially for the same purpose. Even though a different needle is used for each insulin injection, only one needle is used at a time, so all the needles together are herein considered a single medical device. Therefore, in this example, the storage device 340 holds data indicative of the insertion sites that have been used by the patient for the CGM sensor 112, and also holds data indicative of the insertion sites that have been used by the patient to inject insulin, or that have been used by another individual (e.g., an HCP) to inject insulin into the patient. Insertion sites can be tracked for any number of medical devices.

The processor 386 is configured to determine that each of the insertion sites is recommended for the first medical device, the second medical device, both of the medical devices, or neither of the medical devices. The processor 386 can perform this determination using the stored medical records, the stored indication, the data of the plurality of insertion sites, and the data indicative of the used insertion sites for the first and second medical devices. Examples of this determination are discussed below. The processor 386 is configured to present on the display 444 a visual representation 1049 of at least some of the insertion sites and the determined respective recommendations.

In the example shown in FIG. 10, the highlights 1041, 1042, and 1043 are graphical representations of insertion sites recommended for the first medical device. The highlights 1044 and 1045 are graphical representations of insertion sites recommended for the second medical device. A highlight 1046 is a graphical representation of an insertion site that is not recommended for either medical device. Colors, fill patterns, borders, or other visual indications can be used to differentiate the highlights 1041, 1042, 1043, 1044, 1045, 1046 from each other.

The processor 386 receives via the input device a selection of one of the displayed insertion sites and a selection of one of the medical devices. In the example shown, the touch location 1010 shows that the user has touched the highlight 1041. Two graphical buttons 1001, 1002 permit the user to choose which medical device the touch location 1010 corresponds to. The graphical button 1001 represents an insulin pump and the graphical button 1002 represents a CGM sensor. In this example, the user has touched the graphical button 1001 (the pump), so the processor 386 presents the graphical button 1001 with a highlight or other indication (e.g., a radio button) that the pump has been chosen. The processor 386 is configured to update the stored data indicative of the used insertion sites for the selected one of the medical devices with the selected one of the insertion sites. In this example, the processor 386 updates the data in the storage device 340 to indicate that the insertion site corresponding to the highlight 1041 has recently been used for the first medical device.

In an example, the input device is the touch sensor 445, FIG. 4, configured with respect to the display 444 to form a touchscreen. The processor 386 is configured to receive the selection of the insertion site by detecting a touch on the touchscreen at a location corresponding to the visual representation of one of the displayed insertion sites. The insertion site corresponding to the touched visual representation is selected.

In various embodiments, the processor 386 is configured to present the visual representation showing only ones of the plurality of insertion sites that are recommended for the selected one of the medical devices or both of the medical devices. In this example, when the user selects the graphical button 1001, the visual representations of insertion sites that are not recommended for the pump are hidden. Similarly, when the user selects the graphical button 1002, the visual representations of insertion sites that are not recommended for the CGM are hidden. Insertion sites that are recommended for both the pump and the CGM will be indicated by visual representations when either of the graphical buttons 1001, 1002 is selected.

The processor 386 can be configured to determine site recommendations in various ways. For example, the processor 386 can be further configured to determine that each of the plurality of insertion sites is recommended for one of the medical devices only if that one of the plurality of insertion sites is not indicated in the stored data for the corresponding one of the medical devices as having been used less than a selected time ago. This provides a basic rotation of insertion sites by not recommending a recently-used insertion site until sufficient time has passed for the subject's body to heal.

In another example, the user selects the upper-arm insertion site corresponding to the highlight 1041 for the CGM sensor. For the next week (a usage period), the highlight 1041 will indicate that insertion site is recommended for the CGM sensor. After the week has passed, as indicated in the stored data for the CGM sensor, the processor 386 will display the highlight 1041 to indicate that insertion site is not recommended for the CGM sensor. The highlight 1041 will indicate “not recommended” until three weeks have passed (a rest period). This supports an established practice or routine described in Frid of using injections spaced 1 cm apart within a particular insertion site over the course of one week (see Frid sec. 3.14). Specifically, in various embodiments the processor 386 is configured to determine that each of the plurality of insertion sites is recommended for one of the medical devices only if either that one of the plurality of insertion sites has been used within a selected usage period, as indicated in the stored data for the corresponding one of the medical devices, or that one of the plurality of insertion sites is not indicated in the stored data for the corresponding one of the medical devices as having been used during a selected rest period.

In various embodiments, the medical records stored in the storage device 340 are compared to stored criteria to determine recommended sites. For example, insulin is preferably injected into subcutaneous (SC) tissue. Frid section 3.11.2 describes that the thickness of SC tissue can vary depending on, among other things, body-mass index (BMI). The thickness of SC tissue can also vary between insertion sites on the patient's body. In various embodiments, the storage device 340 further stores data defining a medical criterion applicable to a selected one of the plurality of insertion sites and a selected one of the medical devices. The processor 386 is configured to determine whether the stored medical records satisfy the criterion and, if not, that the selected one of the insertion sites is not recommended for the selected one of the medical devices. As used herein, the term “medical records” is intended to also include any of the electronic medical records (EMR) utilized in clinics and hospitals.

For example, the selected one of the medical devices can be a syringe with an 8 mm needle. The selected one of the plurality of insertion sites can be an upper-thigh site, e.g., indicated by the highlight 1043. Frid FIG. 2 shows study results indicative of the that SC fat tissue in that insertion site has a mean of 7 mm and a range of 2-22 mm in men, and a mean of 14 mm and a range of 5-34 mm in women. These data, or other known clinical data, can also be stored in the storage device 340. An exemplary criterion, for this insertion site and for the syringe described above, is that the SC tissue be at least 4 mm thick so that a skin fold will leave a 6 mm thick area into which the 8 mm syringe needle can be inserted without entering the muscle below the SC tissue. The stored medical records can indicate that the patient is male and has an average BMI. The processor 386 can use the stored medical records of the patient and the stored clinical data to infer that the patient likely has 7 mm of SC tissue at this insertion site. Since 7 mm>4 mm, the processor 386 determines that this insertion site should not be disqualified by the stored criterion. The processor 386 may, however, determine that this insertion site should not be recommended for other reasons.

If the stored medical records indicate that the patient has an extremely low BMI, the processor 386 can infer that the SC thickness is 2 mm. Since 2 mm<4 mm, the criterion is not satisfied. Accordingly, in this example the processor 386 determines that this insertion site (upper thigh) is not recommended for use with the syringe. This insertion site may, however, still be recommended for a different medical device other than the syringe. Specifically, in various embodiments, the processor 386 is configured to determine whether there is likely to be subcutaneous fat in the patient's body at each of the plurality of insertion sites using the stored medical records. The processor determines that each of the plurality of insertion sites is recommended only if there is likely to be subcutaneous fat at that one of the plurality of insertion sites.

Similarly, the medical records can include data indicative of the patient's weight. Weight can indicate whether or not the subject 1138 is muscular. Since insulin injection is subcutaneous, injecting into certain insertion sites can be painful if the user is muscular. Using the weight stored in the storage device 340, the processor 386 can infer (how muscular or not the subject 1138 is. The processor 386 can then determine sites are not recommended if they are likely to be painful to users with the given weight.

In other examples, the processor 386 can determine a recommendation for each of the insertion sites based on the medical records indicating whether the subject 1138 has Type 1 or Type 2 diabetes. Preferred insertion sites for the two types can be different, so sites specifically for one type are determined not to be recommended if the medical records indicate the subject 1138 has the other type.

In another example, the processor 386 is configured to coordinate the use of the first and second (or more) medical devices. The processor 386 receives an indication of one of the plurality of insertion sites that is in use by the first medical device, e.g., the CGM sensor 112. This is represented in FIG. 10 by an indication 1012 on the highlight 1042, which represents the left-abdomen insertion site. The indication 1012 can be received from the input device, e.g., the touch sensor 445 or a pointing device such as a joystick. The processor 386 then determines that each of the plurality of insertion sites within a selected distance of the indicated insertion site is not recommended for the second medical device. This is graphically represented by a circular zone 1014 that includes part or all of the highlights 1042, 1045, 1046. Accordingly, the processor 386 determines that the insertion sites corresponding to the highlights 1042, 1045, and 1046 are not recommended for, e.g., the insulin pump (or other second medical device). This advantageously, helps the user, e.g., avoid accidentally inserting insulin too close to the CGM sensor 112 and thereby reducing the accuracy of glucose measurements by the CGM sensor 112. The selected distance can be determined from the periphery or center of an insertion site, or another selected point within the insertion site.

In general, the processor 386 can be configured to apply various criteria to one or more of the insertion sites. Examples of such criteria discussed above include recency of use, proximity to insertion sites used for another device, and stored medical criteria. The processor 386 is configured to determine insertion site(s) (if any) that are not recommended, and to represent that determination visually to the user. Different criteria can be applied to different insertion sites. For example, stored medical records can be compared to stored criteria to determine whether certain of the insertion sites are not recommended, and recency criteria can be applied to others of the insertion sites. Multiple criteria can also be applied to the same insertion site. In various embodiments, the processor tests each insertion site against multiple stored criteria, e.g., the exemplary criteria described above. Each insertion site is recommended if and only if it satisfies each of the stored criteria.

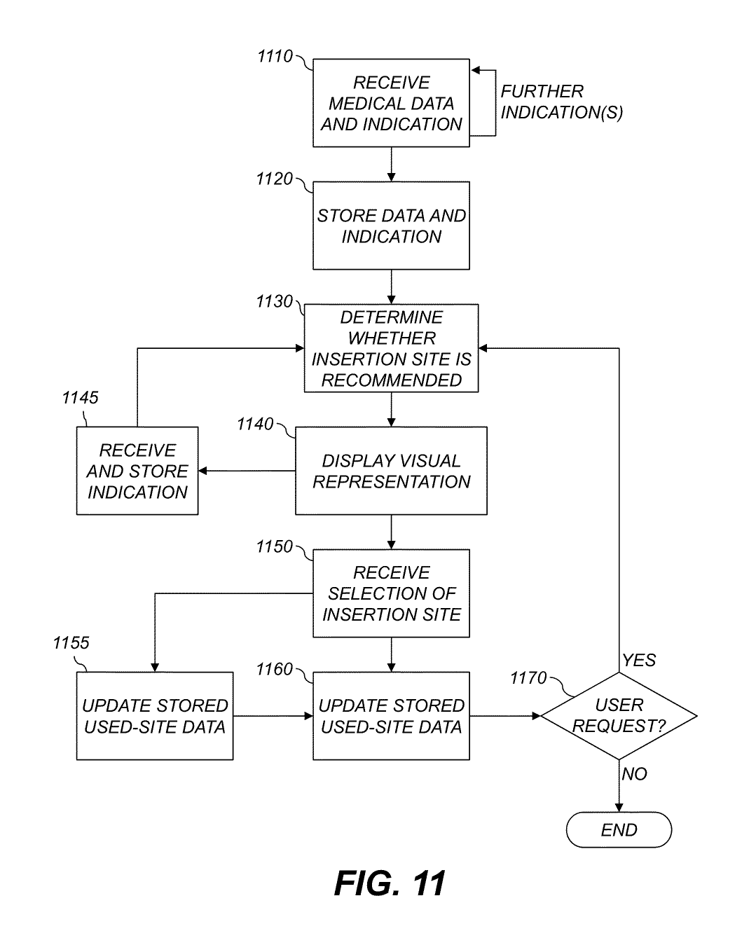

FIG. 11 is a flowchart illustrating an exemplary method for recommending an insertion site. The method includes automatically performing steps described herein using a processor. For purposes of this exemplary embodiment, processing begins with step 1110. For clarity of explanation, reference is herein made to various components shown in FIGS. 1-4 that can carry out or participate in the steps of the exemplary method, and to various visual representations shown in FIGS. 4-10 that can be provided following steps of the exemplary method. It should be noted, however, that other components can be used and other visual representations can be provided; that is, the exemplary method is not limited to being carried out by the identified components or to providing the identified visualizations.

In step 1110, medical records of a patient are received via a user interface. The user interface can include a touchscreen 144, FIG. 1 (e.g., the display 444 with the touch sensor 445, both FIG. 4). An indication of an insertion site that should not be used is also received via the user interface. An example of such an indication is a touch on a visual representation displayed on the touchscreen 144, e.g., a touch on the highlight 1046 represented as an indication 1050, both FIG. 10. The indication can be, e.g., an indication of an insertion site already in use by another medical device such as the CGM sensor 112, as discussed above with reference to the indication 1012, FIG. 10. Receiving the indication permits users to control their infusion sites with respect to pain, discretion (e.g., for users who habitually wear short sleeves), or other factors known to the user. The indication can be received from the user or patient, or from an HCP. Step 1120 can be next.

In step 1120, the medical records and the indication are stored in the storage device 340, FIG. 4. Step 1130 can be next.

In step 1130, it is determined, e.g., by the processor 386, whether each of the insertion sites is recommended using the stored medical records, the stored indication, stored data of a plurality of insertion sites, and stored data indicative of the used insertion sites. That is, a determination of whether an insertion site is recommended or not is made for each of the insertion sites. Other insertion areas can be presented, but a determination not made for those areas. The insertion site indicated as not to be used, e.g., the insertion site corresponding to the highlight 1046, as indicated by the indication 1050, is determined to be not recommended. This advantageously permits users to, e.g., exclude from a rotation insertion sites that are particularly painful to insert into, or that are difficult for the patient or an HCP to reliably insert into. Step 1140 can be next.

In step 1140, a visual representation of the plurality of insertion sites is displayed, e.g., on the touchscreen 144 or the display 444. Examples of such representations are shown in FIG. 5, e.g., the highlights 448. Other insertion areas can also be displayed. In various embodiments, a visual representation of whether each of the plurality of insertion sites is recommended is also displayed. For example, the highlight 1046, FIG. 10, is a visual representation of an insertion site that is not recommended, while the highlight 1041, also FIG. 10, is a visual representation of an insertion site that is recommended. Recommendations can be determined and presented with respect to only a single medical device, e.g., an insulin-injection syringe or pen, or an epi-pen for injecting epinephrine, or with respect to multiple medical devices, as discussed above with reference to the graphical buttons 1001, 1002, FIG. 10. In some embodiments, the user interface includes the touchscreen 144, and this step 1140 includes displaying the visual representation on the touchscreen 144. Step 1150 can be next.

In various embodiments, step 1140 is followed by step 1145. In step 1145, the indication 1050 of an insertion site that should not be used is received. The indication can be received in step 1145 instead of in step 1110, or a first indication can be received in step 1110 and a second indication received in step 1145. The indication can be received (e.g., by the suitably-configured processor 386, FIG. 3) by detecting a touch on the touchscreen in an area corresponding to the visual representation of one of the insertion sites. In an example, the user touches a graphical button 1003, FIG. 10, to indicate to the controller 104 that the next touch will be the indication 1050. The user then touches the highlight 1046 to provide the indication 1050. The indication 1050 is then stored as described above with reference to step 1110.

Multiple indications can be received and stored in step 1145. In step 1145 or step 1110, cancellations can also be received, e.g., by the suitably-configured processor 386. A cancellation, e.g., a second touch on the highlight 1046 after providing the indication 1050, removes the corresponding insertion site from the stored list of insertion sites that should not be used. The graphical buttons 1001, 1002, 1003 can be color-coded with respect to the highlights 1041, 1042 1043, 1044, 1045, 1046, or otherwise designed to suggest their functions to the user.

In various embodiments, step 1145 is followed by step 1130. After the indication 1050 is received, it is re-determined (e.g., by the processor 386) whether each of the insertion sites is recommended. In an example, a user indication that a certain site is not to be used for a pump may cause nearby sites to be recommended for a CGM sensor, since it can be determined that the pump will not be used at the indicated insertion site.

In step 1150, a selection of one of the insertion sites is received via the user interface, e.g., via a touch on the touchscreen 144. This is shown, e.g., by the touch indicator 610, FIG. 6. Step 1155 or step 1160 can be next.

In step 1160, the stored data indicative of the used insertion sites are updated with the selected one of the insertion sites. This advantageously permits the processor 386 or another device carrying out steps of this method to provide suggestions for rotating insertion sites for one or more medical device(s). Decision step 1170 can be next.

In decision step 1170, it is determined whether the patient has made a request to repeat the process, e.g., by pressing the soft key 412, FIG. 4. If so, the next step can be step 1130. In this way, the determining, displaying, receiving, or updating steps are repeated at the request of the patient. Some steps can be omitted. For example, the user can request only a display of recommended sites, in which case steps 1150, 1160 are not performed.

In step 1155, in various embodiments, the processor 386 determines whether the selected one of the insertion sites (from step 1150) is recommended. If the selected one of the insertion sites is not recommended, an indication is displayed, e.g., on the touchscreen 144. An example is shown in FIGS. 7 and 8. The user touches or otherwise selects a right-abdominal insertion site that is not recommended. The visual representation 720 can be appropriately colored (here, red, as indicated by the hatching) to indicate this, and the explanatory message 825 provides further information.

In various embodiments, a second or subsequent indication of an insertion site that should not be used can be received. This is represented by the “further indication(s)” arrow from step 1110 to itself in FIG. 11. Each insertion site corresponding to a received indication is determined not to be recommended. One or more of the received indication(s) can be stored in the storage device 340, e.g., in a nonvolatile memory. Step 1110 can include retrieving the indications from the storage device 340 instead of, or in addition to, receiving indications from the user. In various embodiments, the stored indication in the storage device is automatically replaced with the second indication using the processor 386. In this way, only one insertion site (or a certain number of insertion sites) is indicated as one that should not be used at any given time. The user can change which insertion site that is at any time, e.g., when repositioning the CGM sensor 112 or the infusion set 106, FIG. 1. In other embodiments, the second indication is automatically stored in the storage device so that whether each of the insertion sites is recommended is further determined using the stored second indication.

In view of the foregoing, embodiments of the invention provide improved management of insertion site rotation. A technical effect of processing performed by the processor 386 is to compute insertion-site recommendations using data provided, e.g., by the user of the controller 104 and to compute graphical representations of those recommendations. Another technical effect is to communicate those recommendations or representations outside the particular computing device that performed the computations, e.g., to a human who may use the recommendations in selecting insertion sites for, e.g., insulin pumps or needles or CGM sensors. Various decision-support systems and devices described herein can be integrated with, e.g., episodic blood glucose meters or drug-delivery devices. Various methods described herein can be performed by processors in such meters or devices.

### PARTS LIST FOR FIGS. 1-11

100 system
102 drug delivery device
104 controller
106 infusion set
108 flexible tubing
110, 111 radio frequency communications link
112 CGM sensor
113 radio frequency communications link
114 glucose meter
115 test strip
116 network
117, 118 radio frequency communications link
125 test strip
126 server
128 storage device
130 housing
144 touchscreen
200 biosensor
201, 202 electrical contact pads
204 planar substrate
210, 220 electrodes
230 sample-receiving chamber
315 communication interface
316 network link
320 peripheral system
330 user interface
340 storage device
341 memory
342 disk
350 network
386 processor
400 system
405 earpiece
407 mouthpiece
410 switch
411,412,413,414 soft keys
420 headphone jack
430 docking port
431 antenna
444 display
445 touch sensor
448 highlights
449 representation
451, 452, 454 soft-key labels
510 prompt
610 touch indicator
648 highlight
720 visual representation
825 explanatory message
830 graphical button
920 visual representation
925 explanatory message
1001, 1002, 1003 graphical buttons
1010 touch location
1012 indication
1014 zone
1041, 1042, 1043, 1044 highlights
1045, 1046 highlights
1049 visual representation
1050 indication
1110, 1120, 1130 steps
1138 subject
1140, 1145, 1150, 1155 steps
1160 step
1170 decision step

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Separate references to “an embodiment” or “particular embodiments” or the like do not necessarily refer to the same embodiment or embodiments; however, such embodiments are not mutually exclusive, unless so indicated or as are readily apparent to one of skill in the art. The use of singular or plural in referring to “method” or “methods” and the like is not limiting. The word “or” is used in this disclosure in a non-exclusive sense, unless otherwise explicitly noted. To the extent there are variations of the invention that are within the spirit of the disclosure or are equivalent to the inventions found in the claims, it is the intent that this patent will cover those variations as well.

What is claimed is:

1. A decision support system for a patient, the system comprising:
a) a user interface including a display and an input device;
b) a processor coupled to the user interface to provide graphic output and receive input; and
c) a storage device coupled to the processor and holding:
i) data of a plurality of insertion sites, each insertion site representing an area on a human body at which a medical device can be inserted into the body; and
ii) data indicative of insertion sites that have been used by the patient;
d) the processor being configured to receive via the user interface medical records of the patient and an indication of an insertion site that should not be used and store the medical records and the indication in the storage device, so that the processor:
i) determines whether each of the insertion sites is recommended via the stored medical records, the stored indication, the data of the plurality of insertion sites, and the data indicative of the used insertion sites;
ii) presents on the display a visual representation of at least some of the insertion sites and whether each of the at least some of the insertion sites is recommended;
iii) receives a selection of one of the displayed insertion sites via the user interface; and
iv) updates the stored data indicative of the used insertion sites with the selected one of the insertion sites.

2. The system according to claim 1, wherein the processor is further configured to repeatedly determine the recommendations, present the representations, receive the selections, and update the stored data.

3. The system according to claim 1, wherein the processor is configured to determine whether the selected one of the insertion sites is not recommended and, if not, to present an indication on the display.

4. The system according to claim 1, wherein the processor is configured to process the stored medical records to determine whether there is likely to be subcutaneous fat in the patient's body at each of the plurality of insertion sites, so that the processor determines that each of the plurality of insertion sites is recommended only if there is likely to be subcutaneous fat at that one of the plurality of insertion sites.

5. The system according to claim 1, wherein the processor is configured to present the visual representation of one or more of the insertion sites that are different from the insertion site indicated as the one that should not be used.

6. The system according to claim 1, wherein the input device comprises a touch sensor configured with respect to the display to form a touchscreen, and the processor is configured to receive the selection by detecting a touch on the touchscreen at a location corresponding to the visual representation of one of the displayed insertion sites.

7. A decision support system for a patient, the system comprising:
a) a user interface including a display and an input device;
b) a processor connected to the user interface to provide graphic output and receive input; and
c) a storage device coupled to the processor and holding:
i) data of a plurality of insertion sites, each insertion site representing an area on a human body at which a medical device can be inserted into the body;
ii) medical records of the patient;
iii) data indicative of the insertion sites that have been used by the patient for a first medical device; and
iv) data indicative of the insertion sites that have been used by the patient for a second medical device different from the first medical device;
d) the processor being configured to determine that each of the insertion sites is recommended for the first medical device, the second medical device, both of the medical devices, or neither of the medical devices via the stored medical records, the stored indication, the data of the plurality of insertion sites, and the data indicative of the used insertion sites for the first and second medical devices, so that the processor:
i) presents on the display a visual representation of at least some of the insertion sites and the determined respective recommendations;
ii) receives via the input device a selection of one of the displayed insertion sites and a selection of one of the medical devices; and
iii) updates the stored data indicative of the used insertion sites for the selected one of the medical devices with the selected one of the insertion sites.

8. The system according to claim 7, wherein the processor is further configured to receive an indication of one of the plurality of insertion sites that is in use by the first medical device, so that the processor determines that each of the plurality of insertion sites within a selected distance of the indicated insertion site is not recommended for the second medical device.

9. The system according to claim 7, wherein the processor is configured to present the visual representation showing only ones of the plurality of insertion sites that are recommended for the selected one of the medical devices or both of the medical devices.

10. The system according to claim 7, wherein the storage device further stores data defining a medical criterion applicable to a selected one of the plurality of insertion sites and a selected one of the medical devices, and the processor is configured to determine whether the stored medical records satisfy the criterion and, if not, that the selected one of the insertion sites is not recommended for the selected one of the medical devices.

11. The system according to claim 7, wherein the processor is further configured to determine that each of the plurality of insertion sites is recommended for one of the medical devices only if that one of the plurality of insertion sites is not indicated in the stored data for the corresponding one of the medical devices as having been used less than a selected time ago.

12. The system according to claim 7, wherein the input device comprises a touch sensor configured with respect to the display to form a touchscreen, and the processor is configured to receive the selection of one of the displayed insertion sites by detecting a touch on the touchscreen at a location corresponding to the visual representation of the one of the displayed insertion sites.

13. A method of recommending an insertion site, the method comprising automatically performing the following steps using a processor:
receiving, via a user interface, medical records of a patient and an indication of an insertion site that should not be used;
storing the medical records and the indication in a storage device;
determining whether each of the insertion sites is recommended using the stored medical records, the stored indication, stored data of a plurality of insertion sites, and stored data indicative of the used insertion sites;
displaying a visual representation of the plurality of insertion sites;
receiving a selection of one of the insertion sites via the user interface;
updating the stored data indicative of the used insertion sites with the selected one of the insertion sites; and
repeating the determining, displaying, receiving, or updating steps at the request of the patient.

14. The method according to claim 13, further including determining whether the selected one of the insertion sites is recommended, and if not, displaying an indication.

15. The method according to claim 13, further including receiving a second indication of an insertion site that should not be used.

16. The method according to claim 15, further including automatically replacing the stored indication in the storage device with the second indication using the processor.

17. The method according to claim 15, further including automatically storing the second indication in the storage device so that whether each of the insertion sites is recommended is further determined using the stored second indication.

18. The method according to claim 13, wherein the medical records include one or more items selected from the group consisting essentially of an indication of whether the patient has Type I diabetes or Type II diabetes, a height of the patient, a weight of the patient, a gender of the patient, and an age of the patient, and combinations thereof.

19. The method according to claim 13, wherein the step of displaying the visual representations further includes displaying a visual representation of whether each of the plurality of insertion sites is recommended.

20. The method according to claim 13, wherein the user interface includes a touchscreen, and the step of displaying the visual representation includes displaying the visual representation on the touchscreen.
